(19) United States
(12) Patent Application Publication
(10) Pub. No.: US 2023/0013892 A1
(43) Pub. Date: Jan. 19, 2023

(54) DETECTION DEVICE AND DETECTION METHOD

(71) Applicant: 3M INNOVATIVE PROPERTIES COMPANY, St. Paul, MN (US)

(72) Inventor: Kazuma Nuno, Kanagawa (JP)

(21) Appl. No.: 17/787,416

(22) PCT Filed: Dec. 10, 2020
(86) PCT No.: PCT/IB2020/061787

§ 371 Date: Jun. 20, 2022

(30) Foreign Application Priority Data
Dec. 24, 2019 (JP) 2019-233019

(51) Int. Cl. G06T 7/60; G06T 7/00; G06T 7/50; G06V 10/60; G06V 10/98

(52) U.S. Cl. CPC G06T 7/60; G06T 7/0002; G06T 7/50; G06V 10/60; G06V 10/98; G06V 2201/07

(57) ABSTRACT

Provided are a detection device (1) and a detection method that can detect a state of a surface of an object while reducing a constraint of a distance from the object, with a simple device configuration and easy processing. The detection device (1) includes a light source (2) that irradiates an object (10) with light (L1, L2), an image acquisition unit that acquires an image of the object, and a detection unit that detects, based on the image, a state of a surface of the object including a retro reflective material (11) on the surface.

### TECHNICAL FIELD

The present invention relates to a detection device and a detection method.

### BACKGROUND

A device described in Patent Literature 1 is known as a detection device that detects a state of a surface of an object. The detection device defines, in a coordinate system based on a ray axis connecting a light source to a two-dimensional shaded image, a rotation angle of a normal line of the two-dimensional shaded image with respect to a rotational direction of the ray axis as a first angle, and an angle formed by the ray axis and the normal line as a second angle, and determines whether or not smoothness of a surface of a target object can be obtained based on the first angle. When the detection device determines that image information indicating the smoothness of the surface of the target object cannot be obtained, the detection device defines the first angle by repeated calculation, and when the detection device determines that image information indicating the smoothness of the surface of the target object can be obtained, the detection device restores the two-dimensional shaded image to a three-dimensional shape from the first angle 34 and the second angle 31.

### SUMMARY

### Technical Problem

Here, in the detection device described above, there are problems of a need of preparing special hardware and a need of performing complicated information processing in a device of a detection side. In addition, when a distance between an imaging device and an object increases to a certain extent, there is a problem of a decrease in detection accuracy. Thus, there has been a demand for detecting a state of a surface of an object while reducing a constraint of a distance from the object, with a simple device configuration and easy processing.

Accordingly, an object of the present invention is to provide a detection device and a detection method that can detect a state of a surface of an object while reducing a constraint of a distance from the object, with a simple device configuration and easy processing.

Technical Solution to Technical Problem A detection device according to an aspect of the present invention includes a light source configured to irradiate an object with light, an image acquisition unit configured to acquire an image of the object, and a detection unit configured to detect, based on the image, a state of a surface of the object including a retroreflective material on the surface.

A detection method according to an aspect of the present invention includes the steps of: irradiating an object with light from a light source; acquiring an image of the object; and detecting a state of a surface of the object including a retroreflective material on the surface.

### Advantageous Effects of Invention

According to the present invention, it is possible to provide a detection device and a detection method that can detect a state of a surface of an object while reducing a constraint of a distance from the object, with a simple device configuration and easy processing.

### BRIEF DESCRIPTION OF THE DRAWINGS

FIG. 1 is a block configuration diagram illustrating a block configuration of a detection device according to an embodiment of the present invention.

FIG. 2 is a schematic view illustrating a state where an object is irradiated with light from a light source and captured by an imaging device.

FIG. 3 is a flow chart illustrating a method of creating a database.

FIG. 4 is a flow chart illustrating processing executed by a control unit.

FIG. 5 illustrates an example of a data table and an example of a detection result.

FIG. 6A illustrates an example of an image captured by an imaging device.

FIG. 6B illustrates an example of a graph indicating depth information.

FIG. 7 are schematic views illustrating examples of test methods using the detection device.

FIG. 8 are schematic views for explaining constraints in detection by the detection device.

FIG. 9 are schematic views illustrating measures against the constraints illustrated in FIG. 8.

FIG. 10 are graphs illustrating a relation between an angle θ1 and luminance of reflected light.

### DETAILED DESCRIPTION

In the following, an embodiment of the present invention will be described in detail with reference to the drawings.

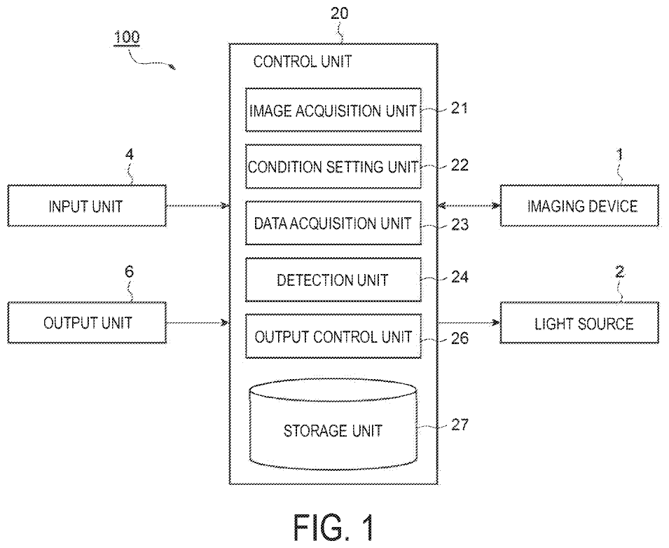

FIG. 1 is a block configuration diagram illustrating a block configuration of a detection device 100 according to an embodiment of the present invention. The detection device 100 is a device that irradiates an object including a retroreflective material on a surface with light and that acquires an image of the object to detect a state of the surface of the object. As illustrated in FIG. 1, the detection device 100 includes an imaging device 1 (image acquisition unit), a light source 2, an input unit 4, an output unit 6 (presentation unit), and a control unit 20.

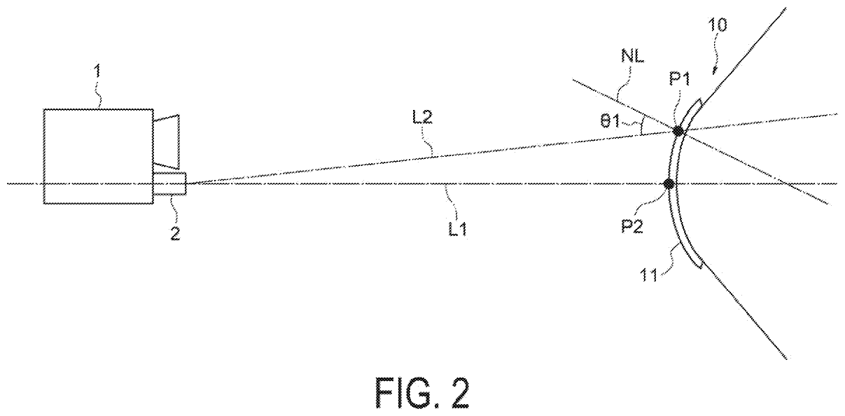

The imaging device 1 is a device that performs capturing to acquire an image. The light source 2 is a device that irradiates an object with light. Specifically, as illustrated in FIG. 2, the light source 2 is provided to be aligned in parallel with a lens of the imaging device. Note that a distance between the lens (not illustrated) of the imaging device 1 and the light source 2 is preferably small such that the imaging device 1 receives retroreflected light. The distance between the lens (not illustrated) of the imaging device 1 and the light source 2 needs to be negligibly small with respect to a distance from an object 10. The light source 2 irradiates the object 10 including a retroreflective material 11 on the surface with light. Note that light generated by the light source 2 spreads radially in predetermined directions, and a central axis of the light is referred to as an irradiation axis L1. A certain point present in the retroreflective material 11 is referred to as an incident point P1. At this time, an angle formed by a normal line NL of the incident point P1 and an incident axis L2 of light is referred to as an “angle θ1.” The imaging device 1 acquires an image of the object 10 irradiated with light. Here, the retroreflective material 11 refers to a member that reflects incident light along an optical path of the incident light.

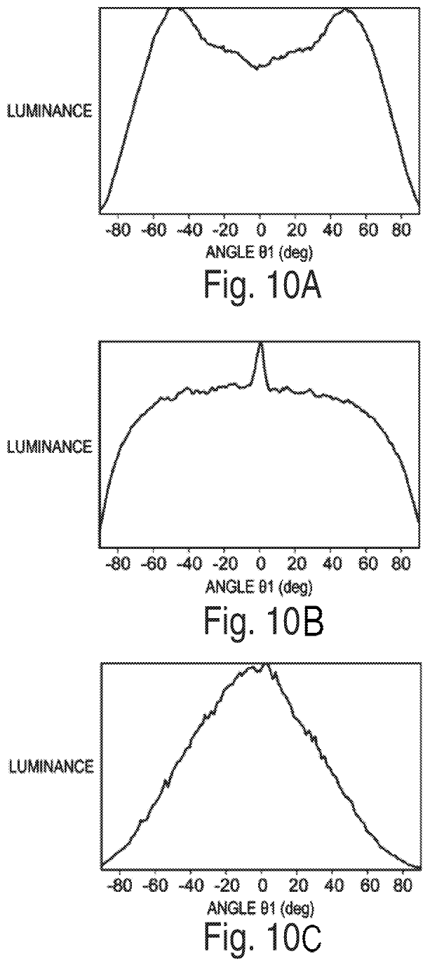

FIG. 10 are graphs illustrating a relation between the angle θ1 and luminance of reflected light. FIGS. 10A, 10B, and 10C illustrate a relation between the angle θ1 and luminance of reflected light in the case of using different types of retroreflective materials, respectively. Reflected light reflected on the retroreflective material 11 varies in luminance according to the angle θ1. For example, as illustrated in FIGS. 10, the relation between the angle θ1 and the luminance varies according to a type of a retroreflective material used. When the angle θ1 is less than a constant value, there is a tendency to reflect light of constant luminance or greater. Accordingly, the retroreflective material 11 in an image is displayed with brightness according to the angle θ1 of each point (pixel).

Returning to FIG. 1, the input unit 4 is a device with which a user inputs various types of information. The input unit 4 includes a mouse, a keyboard, a touch panel, an operation switch, or the like. The output unit 6 is a device that outputs various types of information to a user. The output unit 6 includes a monitor, a speaker, a buzzer, or the like. The output unit 6 can output a detection result of the detection device 100.

The control unit 20 includes an Electronic Control unit (ECU) that comprehensively manages the detection device 100. The ECU is an electronic control unit including a Central Processing Unit (CPU), a Read Only Memory (ROM), a Random Access Memory (RAM), a Controller Area Network (CAN) communication circuit, and the like. The ECU realizes various functions, for example, by loading a program stored in the ROM onto the RAM and causing the CPU to execute the program loaded onto the RAM. The control unit 20 includes an image acquisition unit 21, a condition setting unit 22, a data acquisition unit 23, a detection unit 24, an output control unit 26, and a storage unit 27.

The image acquisition unit 21 acquires data of an image captured by the imaging device 1. That is, the image acquisition unit 21 acquires an image of the object 10 in which the retroreflective material 11 irradiated with light is captured.

The condition setting unit 22 sets various conditions in detecting the state of the surface of the object 10. The conditions set by the condition setting unit 22 include an imaging condition and a condition of a side of the object 10. Examples of the imaging condition include a setting value of the imaging device 1, a setting value such as light intensity of irradiation light of the light source 2, and environmental light. Examples of the condition of a side of the object 10 include a distance between the imaging device 1 and the object 10, a distance between the light source 2 and the object 10, and a type of the retroreflective material 11. The condition setting unit 22 may set the conditions based on information input by a user via the input unit 4. In addition, the condition setting unit 22 may automatically set the conditions based on information such as an image.

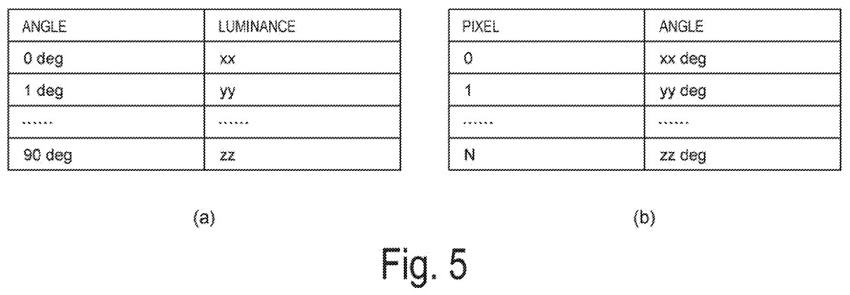

The data acquisition unit 23 acquires information necessary for detecting the state of the surface of the object 10. The data acquisition unit 23 acquires data by reading a data table prepared in advance from the storage unit 27. The data table includes data associating luminance gradient with the angle θ1 formed by the normal line NL and the incident axis L2 of light from the light source 2. For example, as illustrated in table (a) of FIG. 5, the data table includes information of the angle θ1 and information of a luminance gradient in a state where these pieces of information are associated with each other. In the case of the “angle θ1=1 degree” at the incident point P1, a luminance gradient of the incident point P1 in an image is “yy.” The data acquisition unit 23 may acquire a plurality of the data tables according to the imaging condition and the condition of a side of the object 10. That is, even when the angle θ1 is the same, a luminance gradient in an image may vary depending on conditions. In such a case, a different data table may be prepared for each condition. Alternatively, the data acquisition unit 23 may acquire only one representative data table. A specific method of creating the data table will be described below.

The detection unit 24 extracts a region corresponding to the retroreflective material 11 based on an image. For example, since luminance of the region corresponding to the retroreflective material 11 is much greater than luminance of surrounding regions, the detection unit 24 performs processing of extracting a pixel that exceeds a luminance threshold as the region corresponding to the retroreflective material 11. In addition, the luminance threshold for performing the above-described processing may be a fixed value. In addition, for example, a luminance histogram of an image may be created, and a threshold of a mountain observed for greater luminance may be set. The detection unit 24 detects the state of the surface of the object 10 including the retroreflective material 11 on the surface based on an extracted region on an image. The detecting the state of the surface refers to detecting a state of a position in the depth direction of a surface of the object 10. The depth direction refers to the depth as viewed from the imaging device 1. The detecting the state of the surface includes acquiring information directly indicating a state of the depth at each location in a surface, and detecting presence/absence of an abnormality in the depth direction in a surface (for example, an indentation at a location where a surface should be planar). The detection unit 24 detects the state of the surface based on a luminance gradient for a region corresponding to the retroreflective material 11, in an image acquired by the image acquisition unit 21. In addition, the detection unit 24 calculates depth information of a surface based on a luminance gradient of an image.

The detection unit 24 detects the state of the surface by using a data table prepared in advance and acquired by the data acquisition unit 23. The detection unit 24 detects the state of the surface by using a plurality of data tables according to the imaging condition and the condition of a side of the object 10. The detection unit 24 detects the state of the surface by using a plurality of data tables according to a type of the retroreflective material 11. That is, the detection unit 24 compares the conditions set by the condition setting unit 22 with conditions associated in the plurality of data tables, and selects a data table including the closest conditions. Then, the detection unit 24 performs detection by using the selected data table. In addition, the detection unit 24 may correct a data table according to at least one of the imaging condition of the imaging device 1 and the condition of the object 10, and detect the state of the surface based on a corrected data table. Note that the detection unit 24 may use a plurality of data tables and correct a data table selected from among the plurality of data tables according to conditions.

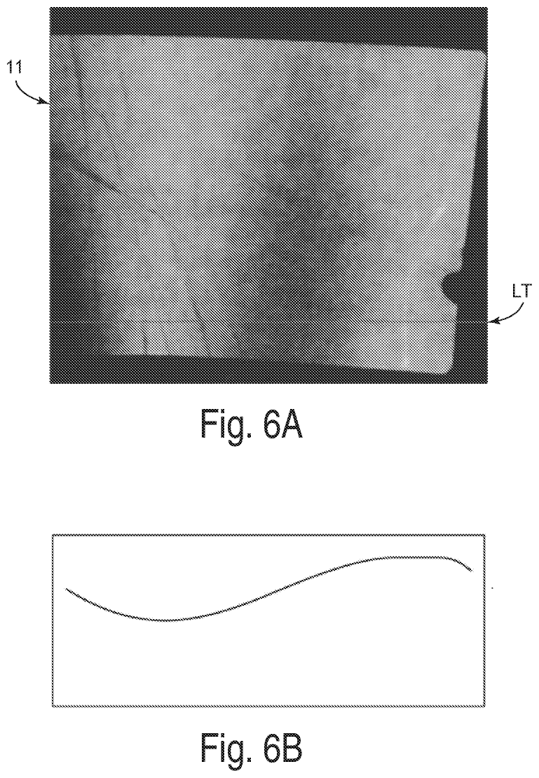

The output control unit 26 controls how the output unit 6 outputs a detection result by the detection unit 24. For example, the output control unit 26 may cause the output unit to display depth information calculated by the detection unit 24 as a graph (for example, see FIG. 6(b)). Alternatively, the output unit 6 may create a three-dimensional model of the object 10 based on a detection result by the detection unit 24 and display the three-dimensional model. Alternatively, the output control unit 26 may only notify a user that there is an abnormality in the state of the surface.

The storage unit 27 stores various types of information used by the detection device 100. As described above, the storage unit 27 stores a data table used by the detection unit 24. A data table created in advance in a laboratory or the like is stored in the storage unit 27 in advance. In addition, the storage unit 27 may store information of past detection results.

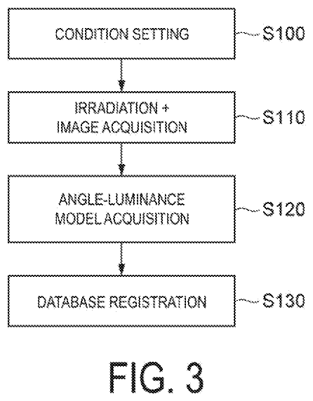

Next, a method of creating a database will be described with reference to FIG. 3. FIG. 3 is a flow chart illustrating the method of creating a database. The method is performed in advance, for example, in a laboratory or the like. As illustrated in FIG. 3, first, a condition setting step of setting a measurement condition is executed (step S100). Here, the conditions listed in the description of the condition setting unit 22 are set. Note that in the case of creating a plurality of databases, a plurality of conditions are combined. Note that the retroreflective material 11 to be captured in the present experiment is preferably set in a state where the retroreflective material 11 is curved at an angle from 0 degree to 90 degrees. Thus, a change in the angle θ1 at each position of the retroreflective material 11 can be increased to acquire data for a wide range of the angle θ1.

Next, an irradiation and image acquisition step of irradiating the retroreflective material 11 set as described above with light from the light source 2 under the conditions set at step S100 and capturing by the imaging device 1 is executed (step S110). Next, a model acquisition step of analyzing an image to acquire a model indicating a relation between the angle θ1 and a luminance gradient is executed (step S120). Here, the image acquired at step S110 is analyzed to acquire a luminance gradient at each position of the retroreflective material 11 in the image, and the acquired luminance gradient is compared with the angle θ1 at each position to acquire a model in which the angle θ1 and the luminance gradient are associated with each other (e.g., table (a) of FIG. 5). Then, a registration step of registering the model acquired at step S120 as a database is executed (step S130).

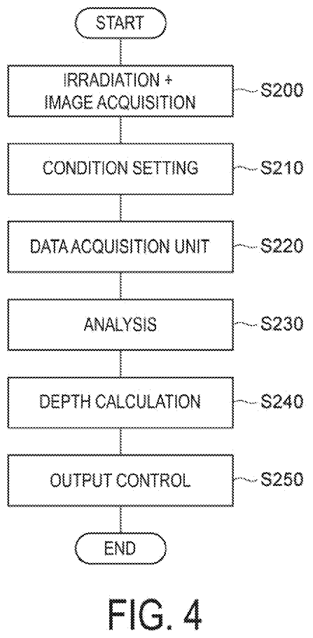

Next, contents of processing performed when the detection device 100 detects the state of the surface of the object 10 will be described with reference to FIG. 4. FIG. 4 illustrates processing executed by the control unit 20. As illustrated in FIG. 4, the control unit 20 executes an irradiation and image acquisition step of irradiating the object 10 with light from the light source 2 and acquiring an image of the object 10 (step S200: irradiation step and image acquisition step). Thus, the image acquisition unit 21 acquires an image as illustrated in FIG. 6A, for example. Next, the condition setting unit 22 executes a condition setting step of setting a condition at the time of detection (step S210). Next, the data acquisition unit 23 executes a data acquisition step of acquiring a database from the storage unit 27 (step S220).

Next, the detection unit 24 executes an analysis step of analyzing the image acquired at step S200 based on the database acquired at step S220 (step S230: detection step). Thus, the detection unit 24 detects the angle θ1 at each position by inquiring the database about a luminance gradient at each position (each pixel) of the retroreflective material 11 in the image (see table (b) of FIG. 5). Next, the detection unit 24 executes a depth calculation step of calculating the depth at each position of the retroreflective material 11 (step S240: detection step). Here, the detection unit 24 grasps a change in the angle θ1 at each position of the retroreflective material 11 in the image, and thus can grasp how a deviation in the depth direction at each position varies. Thus, the detection unit 24 can acquire a graph indicating depth information as illustrated in FIG. 6(b), for example. Note that the graph illustrated in FIG. 6(b) indicates depth information at a location where a line LT is drawn in FIG. 6A. A graph for each position of the retroreflective material 11 can be obtained by vertically shifting the line LT on the image. As a result, depth information in all regions can be acquired. Next, the output control unit 26 executes an output control step of determining how the output unit 6 outputs a detection result by the detection unit 24 (step S250). The output control unit 26 causes the output unit 6 to output information in a set output mode. Thus, the control processing illustrated in FIG. 4 ends. Note that FIGS. 6A and 6B are views explaining an example of two-dimensional deformation (deformation that can be assumed to be uniform in a shape with respect to any cross section in the same direction). As for three-dimensional deformation that cannot be assumed in this manner, calculation is performed by using a principal curvature. The principal curvature refers to a value indicating how much and in which direction a curved surface is bent at each point. The detection unit 24 can convert luminance into the angle θ1 and then calculate a derivative in each direction in the image of the angle θ1 to define the derivative as the principal curvature of a surface. The detection unit 24 can obtain depth information by finding an integral along the direction of the principle curvature.

Next, an example of application of the detection device 100 will be described. As long as the object 10 includes the retroreflective material 11, the detection device 100 can detect the state of the surface by simply acquiring an image. Moreover, since the retroreflective material 11 is used, even when the object 10 is away from the imaging device 1 to some extent, the detection device 100 can detect the state of the surface. Accordingly, the detection device 100 can be used in a variety of application. For example, an operator working at a work site may work wearing working clothes with the retroreflective material 11 for safety. Accordingly, the detection device 100 can monitor a temporal change in depth information of the retroreflective material 11 by simply acquiring an image of the operator at the work site, and thus safety of an operation of the operator can be monitored. In addition, the detection device 100 can be used to check a state of deformation of a tool or the like. For example, the detection device 100 acquires an image of a player wearing a helmet at a venue of an American football game. At this time, the helmet is coated with a paint constituting a retroreflective material. Thus, the detection device 100 can detect deformation of the helmet by detecting unnatural irregularities in a surface of the helmet. In addition, the detection device 100 can also be used for human motion analysis. For example, a person wears clothes made of a material that functions as a retroreflective material. Then, the detection device 100 can detect a human motion by acquiring an image of the person.

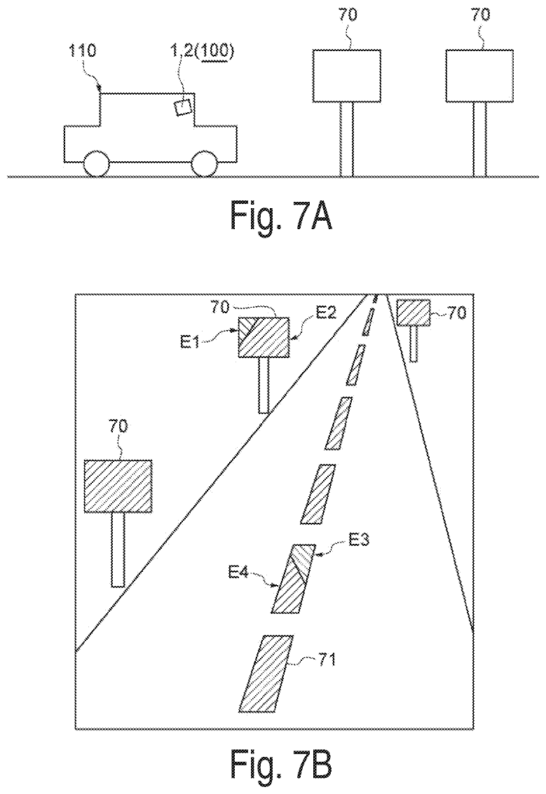

In addition, the detection device 100 can also be used to quickly detect an abnormality of the state of the surface of the object 10. At this time, the detection unit 24 detects an abnormality of the state of the surface based on a luminance difference in a region corresponding to the retroreflective material 11, in an image acquired by the image acquisition unit 21. Then, when the luminance difference exceeds a specific reference, the detection unit 24 detects an abnormality of the state of the surface. For example, as illustrated in FIG. 7, the detection device 100 can be mounted on a vehicle 110, and used to inspect a state of a surface of a road sign 70 or the like. Specifically, as illustrated in FIG. 7A, a vehicle 110 travels on a road while the light source 2 irradiates the front of the vehicle with light and the imaging device 1 acquires an image of the front of the vehicle. Thus, the detection device 100 acquires an image as illustrated in FIG. 7B. At this time, the sign 70 and a pavement marking 71 on a road (a road marking such as a white line, and an yellow line, and a regulation marking) captured in the image are members including the retroreflective material 11. Accordingly, the sign 70 and the pavement marking 71 are displayed in the image in a state where the sign 70 and the pavement marking 71 have predetermined luminance. In the figure, a hatched portion is displayed in a state where the hatched portion has predetermined luminance. Here, the sign 70 and the pavement marking 71 that are normal are flat and thus, displayed at certain luminance in the image. That is, when a luminance difference occurs in a region corresponding to the retroreflective material 11, it is determined that an abnormality of the state of the surface occurs in the region. Accordingly, the detection unit 24 detects a luminance difference in a region of the sign 70 and the pavement marking 71 corresponding to the retroreflective material 11, in the image acquired by the image acquisition unit 21. When the luminance difference exceeds a specific reference, the detection unit 24 detects an abnormality of the state of the surface, such as peeling of the sign 70 and breakage of the pavement marking 71. For example, when luminance of a region E1 of the sign 70 (location hatched in the reverse direction) is significantly different from luminance of other region E2 in the image, the detection unit 24 can detect an abnormality occurring in the state of the surface of the sign 70. In addition, when luminance of a region E3 of the pavement marking 71 is significantly different from luminance of other region E4 in the image, the detection unit 24 can detect an abnormality occurring in a state of a surface of the pavement marking 71.

When the detection device 100 performs inspection as illustrated in FIG. 7, the detection device 100 can inspect the state of the surface of the sign 70 or the like while the vehicle 110 is traveling at a normal speed. Moreover, the detection device 100 can simultaneously inspect a plurality of the signs 70 or the like captured in an image, even when the sign 70 or the like is distant to some extent. For example, it is very inefficient that a human or a dedicated vehicle goes and stops or moves at a low speed near the sign 70 or the like to perform detailed inspection. In particular, it is difficult to perform such inspection on a highway.

Note that when the detection device 100 performs the inspection as illustrated in FIG. 7, the detection unit 24 only needs to detect a luminance difference in an image, and thus, preparation of a database in advance, calculation of depth information, and the like are unnecessary.

Next, improvements for increasing detection accuracy of the detection device 100 will be described. A condition used when the imaging device 1 acquires an image of the retroreflective material 11 can be changed variously. Accordingly, a condition registered with a database may not necessarily coincide with a condition used when the detection device 100 performs detection. Accordingly, when the detection unit 24 performs detection by using a database, a relation between an angle and luminance in the database is calibrated, and then the detection unit 24 performs detection. Specifically, an angle-luminance relation data table is prepared in advance by using combinations of various setting values, target materials, and a distance from an object (parameters) of the light source 2 and the imaging device 1. Then, the detection unit 24 acquires an angle-luminance relation complemented based on a parameter input with the input unit 4 by a user.

Note that the condition setting unit 22 may use other means such as sensing to acquire some of parameters input by a user. For example, the condition setting unit 22 can acquire a setting value of the imaging device 1 from metadata of an image file. In addition, the condition setting unit 22 can estimate a distance from the object 10, from a known size of an object in an image (for example, in the case of the sign 70, a size of an outer frame of a sign plate, a font size of a character, etc.) and the focal length of the imaging device 1. In addition, the condition setting unit 22 can also estimate a distance from a focus position of the imaging device 1.

Additionally, when the object 10 is an object that can be assumed to include at least one point facing the front (angle θ1=0 degree), the detection unit 24 can estimate a maximum value of luminance in an image as luminance corresponding to the “angle θ1=0 degree.” According to this, the detection unit 24 can acquire and complement an angular-luminance relation from a data table. For example, in FIG. 2, at a point P2, the “angle θ1=0 degree”.

Here, the detection device 100 employs the following method as an algorithm for reconstructing depth information from an angle. In the algorithm for reconstructing depth information from an angle, for example, in the case of the above-described two-dimensional deformation, when it is estimated that the angle θ1 at a point is 10 degrees, it is not possible to determine whether the point is tilted by 10 degrees to the left or by 10 degrees to the right. Thus, when the angle is integrated and converted into depth information, for example, it is necessary to assume that curvature is always positive. Depth information obtained as a result of such assumption differs from an actual shape of the object 10, and points (edges) that cannot be differentiated appear at inflection points. Accordingly, at the next stage, these edges are detected based on a threshold of curvature change, and then the following processing is executed from a left end or a right end. That is, a portion surrounded by two edges is alternately inverted, and when left and right shapes of the portion are connected more smoothly (curvature change is smaller) than before the inversion, the result obtained after the inversion is employed, and when not so, the result obtained prior to the inversion is employed.

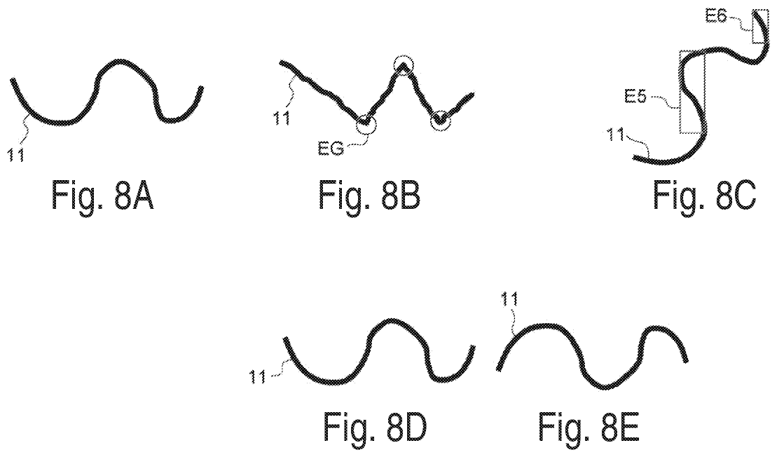

Since the detection device 100 employs the above-described algorithm to reconstruct depth information from an angle, the detection result may be subjected to certain constraint. That is, since the angle θ1 can be detected only as an absolute value from 0 to 90 degrees, it is not possible to determine the direction in which an original point on the object 10 is tilted. Due to this, the detection result is subjected to a constraint. For example, as illustrated in FIG. 8A, when the retroreflective material 11 curves smoothly across the entire region, the detection device 100 easily detects the state of the surface. In contrast, as illustrated in FIG. 8B, when the retroreflective material 11 includes an edge portion EG that sharply changes in an angle, the detection device 100 cannot satisfactorily detect the edge portion EG. In addition, in the case where the imaging device 1 captures an image from only one side (as illustrated in FIG. 8C), regions E5 and E6 in the retroreflective material 11 are blind spots of the imaging device 1, and the detection device 100 cannot perform detection for the regions E5 and E6. In addition, in the case of sequentially inverting from an end, the detection device 100 needs to assume whether the end faces the depth side or the near side, and thus, “two shape candidates related to each other as an mirror image in the depth direction” (FIGS. 8D and 8E) are obtained. However, the detection device cannot determine which of the two shapes is correct. Accordingly, the detection device 100 cannot grasp whether a state of a surface of the retroreflective material 11 is a state illustrated in FIG. 8D or a state illustrated in FIG. 8E.

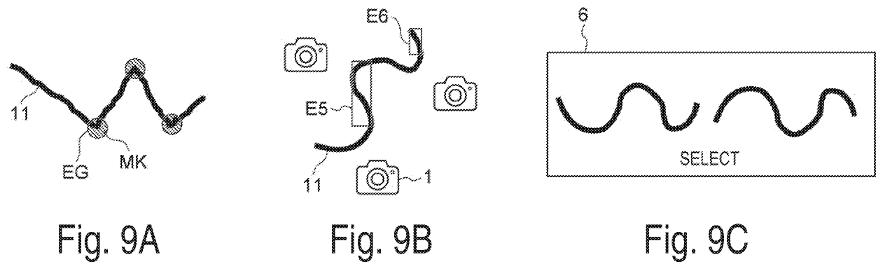

The detection device 100 can address such a constraint. That is, when the retroreflective material 11 includes the edge portion EG, as illustrated in FIG. 9A, a marker MK may be disposed at the edge portion EG. Thus, when the detection device 100 detects the marker MK in an image, the detection device 100 can detect that the position is the edge portion EG. In addition, when there are the regions E5, E6 that are blind spots of one imaging device 1 as illustrated in FIG. 9B, the imaging device 1 may capture the regions E5, E6 from a different position. In addition, as illustrated in FIG. 9C, the output unit 6 (presentation unit) presents a plurality of pieces of depth information determined by the detection unit 24 (here, the two graphs illustrated in FIGS. 8D and 8E) on a monitor. At this time, the monitor may display information prompting a user's input, such as “Select.” Thus, the user inputs a selection result of one of the plurality of pieces of depth information. Alternatively, when the detection unit 24 can determine which of the graphs in FIGS. 8D and 8E is likely to be correct in consideration of past detection results, other circumstances, and the like, the detection unit 24 may automatically select one of the graphs. As other information, for example, in the case of sensing a human body shape, out of shape candidates on the depth side and the near side, the result on the depth side can be discarded easily from prior knowledge that the body shape is on the near side. In addition, as for an object having a known typical shape, a candidate shape can be specified from prior knowledge.

As described above, the detection device according to an aspect of the present invention includes the light source that irradiates an object with light, the image acquisition unit that acquires an image of the object, and the detection unit that detects, based on the image, a state of a surface of the object including a retroreflective material on the surface.

According to the detection device, the detection unit detects, based on an image of an object irradiated with light, a state of a surface of the object including a retroreflective material on the surface. In this manner, since the retroreflective material is used, the detection unit can easily detect a state of a surface of an object by using the light source and the imaging device without using any special equipment or performing complex processing. In addition, the retroreflective material can also reflect light incident over a long distance. Accordingly, even when an object is present at a distant position, the detection unit can detect a state of a surface of the object by reflected light of the retroreflective material. Thus, a state of a surface of an object can be detected while reducing a constraint in a distance from the object, with a simple device configuration and easy processing.

The detection unit may detect the state of the surface based on a luminance gradient of a region corresponding to the retroreflective material, in an image acquired by the image acquisition unit. Thus, the detection unit can easily detect the state of the surface based on the luminance gradient.

The detection unit may calculate depth information of the surface based on the luminance gradient of the image. In this case, the detection unit can use the depth information to communicate the state of the surface to a user in more detail.

The detection unit may detect the state of the surface by using a data table prepared in advance, and the data table may include data associating the luminance gradient with an angle formed by a normal line of each point of the object and an incident axis of light from the light source. Thus, the detection unit can use the data table prepared in advance to easily detect the state of the surface.

The detection unit detects the state of the surface by using a plurality of the data tables according to an imaging condition and a condition of a side of the object. The detection unit can use the plurality of data tables to select a database according to various conditions and perform detection.

The detection unit may correct the data table according to at least one of an imaging condition of the image acquisition unit and a condition of the object, and detect the state of the surface based on a corrected data table. In this case, the detection unit can perform detection according to various conditions by using a small number of data tables.

The detection unit may detect an abnormality of the state of the surface based on a luminance difference in a region corresponding to the retroreflective material, in an image acquired by the image acquisition unit. In this case, the detection unit can easily detect an abnormality based on the luminance difference in the region.

The detection unit detects an abnormality of the state of the surface when the luminance difference exceeds a specific reference. In this case, the detection unit can easily detect an abnormality by comparing the luminance difference to the specific reference.

The detection unit may detect the state of the surface by using a plurality of data tables according to a type of the retroreflective material. In this case, the detection unit can accurately detect according to the type of retroreflective material.

A presentation unit that presents a plurality of pieces of the depth information determined by the detection unit, and an input unit for inputting a selection result of one of the plurality of pieces of depth information may further be provided. In this case, a user can choose a correct selection result.

A detection method includes an irradiation step of irradiating an object with light from a light source, an image acquisition step of acquiring an image of the object, and a detection step of detecting, based on the image, a state of a surface of the object including a retroreflective material on the surface.

According to the detection method, the same actions and effects as those of the detection device described above can be obtained.

The present invention is not intended to be limited to the embodiments described above.

For example, the device configuration illustrated in FIG. 1 and the processing contents illustrated in FIGS. 3 and 4 can be modified appropriately.

1. A detection device comprising:
a light source configured to irradiate an object with light;
an image acquisition unit configured to acquire an image of the object; and
a detection unit configured to:
determine a luminance gradient of a region corresponding to the retroreflective material as represented in the image;
calculate depth information of the surface based on the luminance gradient;
access a data table that was prepared in advance, wherein the data table includes data associating the luminance gradient with an angle formed by a normal line of each point of the object and an incident axis of the light with which the light source irradiates the object and
detect, using a plurality of the data tables according to an imaging condition and a condition of a side of the object, a state of a surface of the object including a retroreflective material on the surface.

2-5. (canceled)

6. The detection device according to claim 1, wherein the detection unit corrects the data table according to at least one of an imaging condition of the image acquisition unit and a condition of the object, and detects the state of the surface based on a corrected data table.

7. The detection device according to claim 1, wherein the detection unit detects an abnormality of the state of the surface based on a luminance difference in a region corresponding to the retroreflective material, in an image acquired by the image acquisition unit.

8. The detection device according to claim 7, wherein the detection unit detects an abnormality of the state of the surface when the luminance difference exceeds a specific reference.

9. The detection device according to claim 1, wherein the detection unit detects the state of the surface by using a plurality of data tables according to a type of the retroreflective material.

10. The detection device according to claim 1, further comprising:
a presentation unit configured to present a plurality of pieces of the depth information determined by the detection unit; and
an input unit for inputting a selection result of one of the plurality of pieces of depth information.

11. A detection method comprising:
irradiating an object with light from a light source;
acquiring an image of the object;
determining a luminance gradient of a region corresponding to the retroreflective material as represented in the image;
calculating depth information of the surface based on the luminance gradient;
accessing a data table that was prepared in advance, wherein the data table includes data associating the luminance gradient with an angle formed by a normal line of each point of the object and an incident axis of the light with which the light source irradiates the object and
detecting, using a plurality of the data tables according to an imaging condition and a condition of a side of the object, a state of a surface of the object including a retroreflective material on the surface.
